(19) United States
(12) Patent Application Publication
(10) Pub. No.: US 2011/0140425 A1
(43) Pub. Date: Jun. 16, 2011

(54) Method and System For Controlling Wind Turbine Rotational Speed

(76) Inventor: Martin Staedler, Berlin (DE)

(21) Appl. No.: 12/868,280

(22) Filed: Aug. 25, 2010

(51) Int. Cl. H02P 9/04

(52) U.S. Cl. 290/44

(57) ABSTRACT

A wind turbine includes a drive train and a brake configured to reduce a rotational speed of the drive train. The wind turbine also includes a brake control system operatively coupled to the brake. The brake control system is configured to selectively operate the brake based on an oscillational characteristic of at least one component of the wind turbine.

### BACKGROUND OF THE INVENTION

The subject matter described herein relates generally to wind turbines and, more particularly, to a method and system for controlling a rotational speed of a wind turbine.

Generally, a wind turbine includes a rotor that includes a rotatable hub assembly having multiple rotor blades. The rotor blades transform wind energy into a mechanical rotational torque that drives one or more generators via the rotor. The generators are sometimes, but not always, rotationally coupled to the rotor through a gearbox. The gearbox steps up the inherently low rotational speed of the rotor for the generator to efficiently convert the rotational mechanical energy to electrical energy, which is fed into a utility grid via at least one electrical connection. Gearless direct drive wind turbines also exist. The rotor, generator, gearbox and other components are typically mounted within a housing, or nacelle, that is positioned on top of a tower.

At least some known wind turbines include a mechanical brake system that facilitates reducing a rotational speed of the rotor. More specifically, a brake caliper applies a force against at least one side of a brake disc, which is coupled to the rotor or to the rotor shaft, creating friction and causing the brake disc to slow and/or stop.

At least some known brake systems may cause vibrations or oscillations within a drive train of the wind turbine when the brake is applied. Moreover, if the wind turbine is disconnected from a power grid, due to a fault or other condition, a torque of the generator may be reduced and/or eliminated. If the brake is applied while the generator is disconnected from the power grid, oscillations within the drive train may be induced and/or amplified. Such oscillations may damage one or more components of the drive train and/or of the wind turbine.

### BRIEF DESCRIPTION OF THE INVENTION

In one embodiment, a wind turbine is provided that includes a drive train and a brake configured to reduce a rotational speed of the drive train. The wind turbine also includes a brake control system operatively coupled to the brake. The brake control system is configured to selectively operate the brake based on an oscillational characteristic of at least one component of the wind turbine.

In another embodiment, a brake system for a wind turbine including a drive train is provided. The brake system includes a brake configured to reduce a rotational speed of the drive train, and a brake control system operatively coupled to the brake. The brake control system is configured to selectively operate the brake based on an oscillational characteristic of at least one component of the wind turbine.

In yet another embodiment, a method is provided for controlling a rotational speed of a wind turbine that includes a drive train and a brake coupled to the drive train. The brake is configured to reduce a rotational speed of the drive train. The method includes extracting an oscillational characteristic of at least one component of the wind turbine from a first signal and selectively operating the brake based on the oscillational characteristic to reduce the oscillational characteristic.

### BRIEF DESCRIPTION OF THE DRAWINGS

FIG. 1 is a perspective view of an exemplary wind turbine.

FIG. 2 is a partial sectional view of an exemplary nacelle suitable for use with the wind turbine shown in FIG. 1.

FIG. 3 is a partial schematic view of an exemplary drive train suitable for use with the wind turbine shown in FIG. 1.

FIG. 4 is a block diagram of an exemplary brake control system suitable for use with the drive train shown in FIG. 3.

FIG. 5 is a flow diagram of an exemplary method for controlling a rotational speed of a wind turbine that is suitable for use with the wind turbine shown in FIG. 1.

### DETAILED DESCRIPTION OF THE INVENTION

The method and system described herein provide a brake system that reduces or eliminates drive train oscillations during a braking operation. The brake system measures an operating condition of at least one component of the wind turbine and generates an acceleration signal based on the measured operating condition. The acceleration signal is filtered to extract a drive train oscillation signal. The brake system selectively operates a brake based on the drive train oscillation signal to reduce and/or eliminate one or more drive train oscillations.

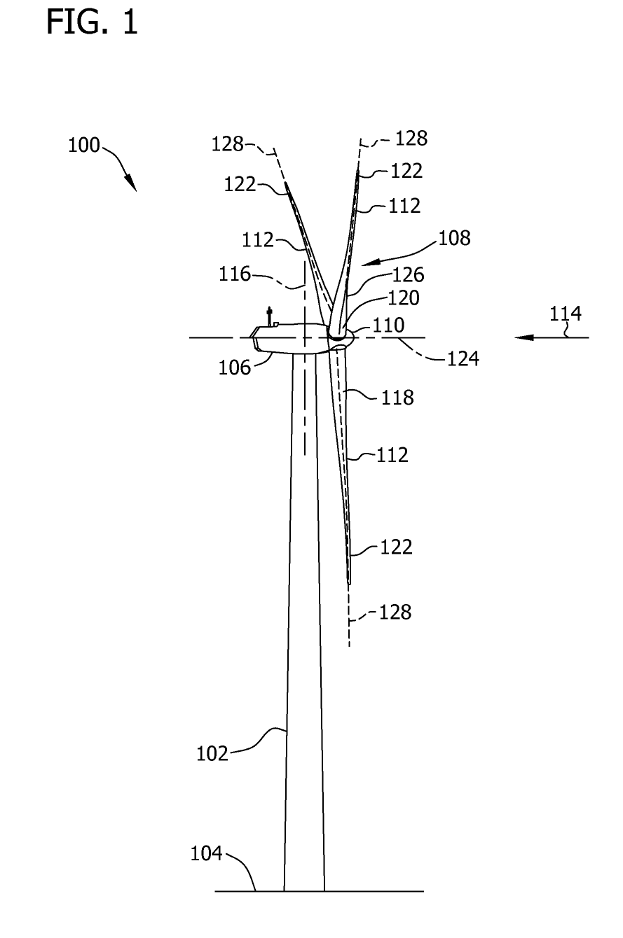

FIG. 1 is a schematic view of an exemplary wind turbine 100. In the exemplary embodiment, wind turbine 100 is a horizontal-axis wind turbine. Alternatively, wind turbine 100 may be a vertical-axis wind turbine. In the exemplary embodiment, wind turbine 100 includes a tower 102 extending from and coupled to a supporting surface 104. Tower 102 may be coupled to surface 104 with anchor bolts or via a foundation mounting piece (neither shown), for example. A nacelle 106 is coupled to tower 102, and a rotor 108 is coupled to nacelle 106. Rotor 108 includes a rotatable hub 110 and a plurality of rotor blades 112 coupled to hub 110. In the exemplary embodiment, rotor 108 includes three rotor blades 112. Alternatively, rotor 108 may have any suitable number of rotor blades 112 that enables wind turbine 100 to function as described herein. Tower 102 may have any suitable height and/or construction that enables wind turbine 100 to function as described herein.

Rotor blades 112 are spaced about hub 110 to facilitate rotating rotor 108, thereby transferring kinetic energy from wind 114 into usable mechanical energy, and subsequently, electrical energy. Rotor 108 and nacelle 106 are rotated about tower 102 on a yaw axis 116 to control a perspective of rotor blades 112 with respect to a direction of wind 114. Rotor blades 112 are mated to hub 110 by coupling a rotor blade root portion 118 to hub 110 at a plurality of load transfer regions 120. Load transfer regions 120 each have a hub load transfer region and a rotor blade load transfer region (both not shown in FIG. 1). Loads induced to rotor blades 112 are transferred to hub 110 via load transfer regions 120. Each rotor blade 112 also includes a rotor blade tip portion 122.

In the exemplary embodiment, rotor blades 112 have a length of between approximately 30 meters (m) (99 feet (ft)) and approximately 120 m (394 ft). Alternatively, rotor blades 112 may have any suitable length that enables wind turbine 100 to function as described herein. For example, rotor blades 112 may have a suitable length less than 30 m or greater than 120 m. As wind 114 contacts rotor blade 112, lift forces are induced to rotor blade 112 and rotation of rotor 108 about an axis of rotation 124 is induced as rotor blade tip portion 122 is accelerated.

A pitch angle (not shown) of rotor blades 112, i.e., an angle that determines the perspective of rotor blade 112 with respect to the direction of wind 114, may be changed by a pitch assembly (not shown in FIG. 1). More specifically, increasing a pitch angle of rotor blade 112 decreases an amount of rotor blade surface area 126 exposed to wind 114 and, conversely, decreasing a pitch angle of rotor blade 112 increases an amount of rotor blade surface area 126 exposed to wind 114. The pitch angles of rotor blades 112 are adjusted about a pitch axis 128 at each rotor blade 112.

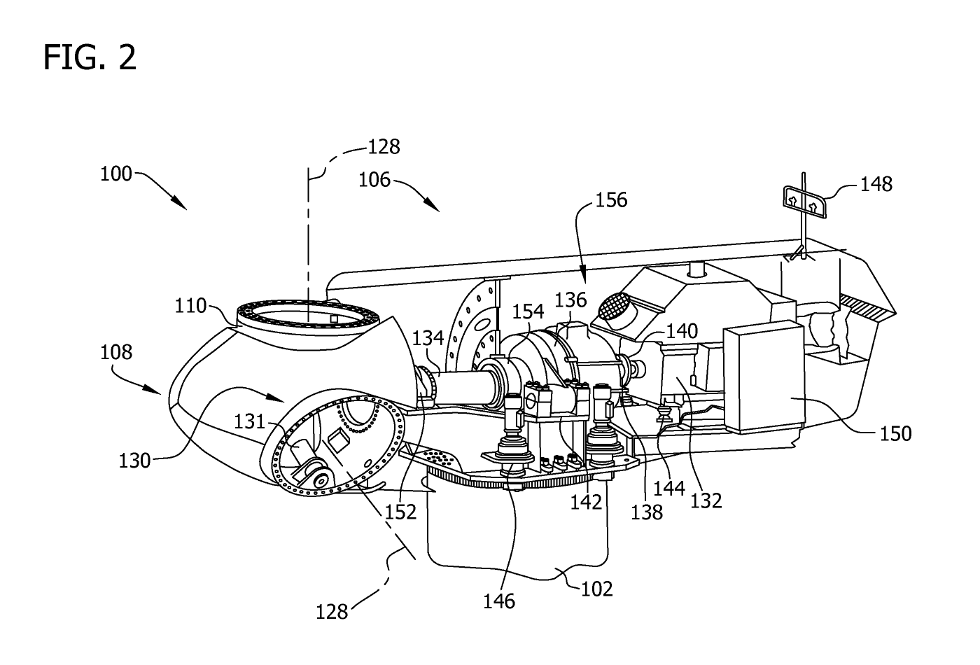

FIG. 2 is a partial sectional view of nacelle 106 of exemplary wind turbine 100 (shown in FIG. 1). Various components of wind turbine 100 are housed in nacelle 106. In the exemplary embodiment, nacelle 106 includes three pitch assemblies 130. Each pitch assembly 130 is coupled to an associated rotor blade 112 (shown in FIG. 1), and modulates a pitch of an associated rotor blade 112 about pitch axis 128. Only one of three pitch assemblies 130 is shown in FIG. 2. In the exemplary embodiment, each pitch assembly 130 includes at least one pitch drive motor 131.

As shown in FIG. 2, rotor 108 is rotatably coupled to an electric generator 132 positioned within nacelle 106 via a rotor shaft 134 (sometimes referred to as either a main shaft or a low speed shaft), a gearbox 136, a high speed shaft 138, and a coupling 140. Rotation of rotor shaft 134 rotatably drives gearbox 136 that subsequently drives high speed shaft 138. High speed shaft 138 rotatably drives generator 132 via coupling 140 and rotation of high speed shaft 138 facilitates production of electrical power by generator 132. Gearbox 136 is supported by a support 142 and generator 132 is supported by a support 144. In the exemplary embodiment, gearbox 136 utilizes a dual path geometry to drive high speed shaft 138. Alternatively, rotor shaft 134 is coupled directly to generator 132 via coupling 140.

Nacelle 106 also includes a yaw drive mechanism 146 that rotates nacelle 106 and rotor 108 about yaw axis 116 (shown in FIG. 1) to control the perspective of rotor blades 112 with respect to the direction of wind 114. Nacelle 106 also includes at least one wind measuring device 148 that includes a wind vane and anemometer (neither shown in FIG. 2). In one embodiment, wind measuring device 148 provides information, including wind direction and/or wind speed, to a turbine control system 150. Turbine control system 150 includes one or more controllers or other processors configured to execute control algorithms. As used herein, the term “processor” includes any programmable system including systems and microcontrollers, reduced instruction set circuits (RISC), application specific integrated circuits (ASIC), programmable logic circuits (PLC), and any other circuit capable of executing the functions described herein. The above examples are exemplary only, and thus are not intended to limit in any way the definition and/or meaning of the term processor. Moreover, turbine control system 150 may execute a SCADA (Supervisory, Control and Data Acquisition) program.

Pitch assembly 130 is operatively coupled to turbine control system 150. In the exemplary embodiment, nacelle 106 also includes forward support bearing 152 and aft support bearing 154. Forward support bearing 152 and aft support bearing 154 facilitate radial support and alignment of rotor shaft 134. Forward support bearing 152 is coupled to rotor shaft 134 near hub 110. Aft support bearing 154 is positioned on rotor shaft 134 near gearbox 136 and/or generator 132. Nacelle 106 may include any number of support bearings that enable wind turbine 100 to function as disclosed herein. Rotor shaft 134, generator 132, gearbox 136, high speed shaft 138, coupling 140, and any associated fastening, support, and/or securing device including, but not limited to, support 142, support 144, forward support bearing 152, and aft support bearing 154, are sometimes referred to as a drive train 156. Drive train 156 may be characterized as a two mass system that may be easily accelerated by one or more forces generated by a brake system and/or any suitable system (not shown in FIG. 2).

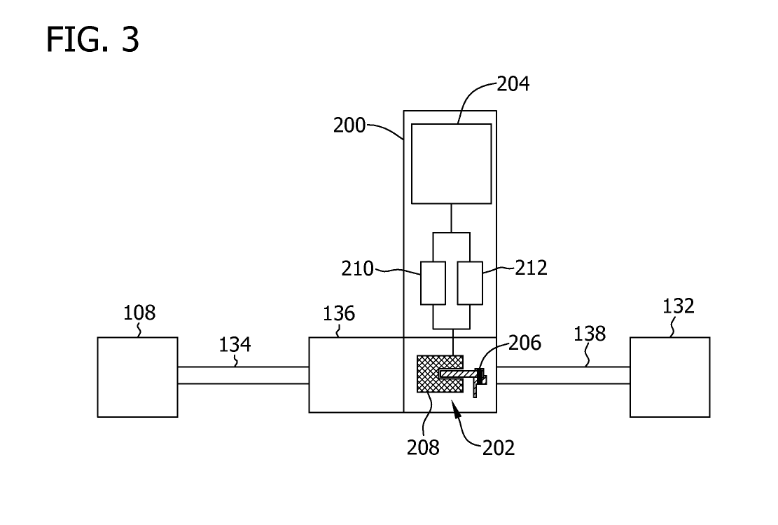

FIG. 3 is a partial schematic view of drive train 156 that is positioned at least partially within nacelle 106 (shown in FIG. 1). Drive train 156 includes a brake system 200 that is at least partially positioned within gearbox 136. Alternatively, brake system 200 is coupled to high speed shaft 138 and/or is coupled to any suitable component of drive train 156 and/or wind turbine 100. Brake system 200 facilitates slowing and/or stopping a rotation of rotor 108 and/or a rotation of generator 132. In the exemplary embodiment, brake system 200 includes a mechanical brake 202 that is operated by hydraulic pressure. Alternatively, brake system 200 may include any suitable brake 202, including, without limitation, a pneumatic brake and/or an electromagnetic brake. Brake system 200 also includes a brake control system 204 that is operatively coupled to and controls an operation of brake 202.

Moreover, in the exemplary embodiment, brake 202 includes a brake disc 206 and at least one brake caliper 208 coupled to brake disc 206. Brake caliper 208 is configured to receive at least a portion of brake disc 206. In the exemplary embodiment, brake caliper 208 is suitably coupled to a first valve 210 and a second valve 212. In the exemplary embodiment, first valve 210 and second valve 212 are coupled together in parallel. In an alternative embodiment, brake system 200 includes a single valve, such as first valve 210. In the exemplary embodiment, first valve 210 cooperates with second valve 212 such that first valve 210 controls a main braking action of brake caliper 208 and second valve 212 controls a fine braking action of brake caliper 208 by introducing an oscillation damping action to brake caliper 208. For example, the main braking action generated by first valve 210 may be used for a general or coarse change or braking action in brake system 200 to reduce a rotational speed of drive train 156, and the oscillation damping action generated by second valve 212 may be used for a delicate or subtle change in brake system 200, such as to reduce or eliminate one or more oscillations in drive train 156. In the exemplary embodiment, brake control system 204 is operatively coupled to first valve 210 to generate the main brake action and to second valve 212 to generate the oscillation damping action. In the exemplary embodiment, first valve 210 and/or second valve 212 are hydraulic valves. Alternatively, first valve 210 and/or second valve 212 may include any suitable valve including, without limitation, mechanical valves, pneumatic valves, and/or electromagnetic valves.

In one embodiment, brake control system 204 may be operated to reduce or eliminate the drive train oscillations when the drive train oscillations exceed a predefined amplitude threshold. The predefined amplitude threshold may be retrieved from turbine control system 150 and/or any other suitable system, and/or may be set by a user during an installation of wind turbine 100 and/or during an operation of wind turbine 100. Alternatively or additionally, brake control system 204 may be operated to reduce the drive train oscillations when a braking operation is initiated, such as when turbine control system 150 and/or another suitable system or user desires to reduce a rotational speed of rotor 108 and/or wind turbine 100.

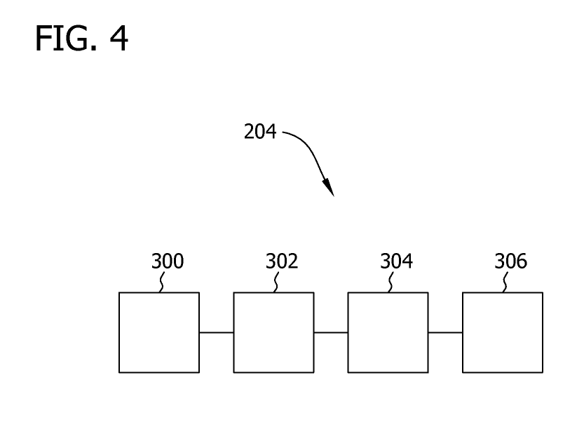

FIG. 4 is a block diagram of brake control system 204. In the exemplary embodiment, brake control system 204 is at least partially implemented by turbine control system 150 (shown in FIG. 2). Alternatively, brake control system 204 is implemented by any suitable system that enables wind turbine 100 (shown in FIG. 1) to operate as described herein. In the exemplary embodiment, brake control system 204 includes one or more sensors 300 that are operatively coupled to one or more components of wind turbine 100 and/or of brake system 200. Sensors 300 measure operating conditions of such components and/or measure other ambient conditions. More specifically, sensors 300 may include, without limitation, one or more transducers configured to measure any suitable operating condition, such as a displacement, yaw, pitch, moment, strain, stress, twist, damage, failure, rotor torque, rotor speed, and/or an anomaly of power supplied to any component of wind turbine 100.

In the exemplary embodiment, each sensor 300 is coupled in electronic signal communication to a calculation module 302 for transmitting one or more suitable signals that are representative of one or more measured operating conditions to calculation module 302 for processing. More specifically, in the exemplary embodiment, at least one sensor 300 transmits a signal representative of a measured rotational speed of rotor 108 (hereinafter referred to as a “rotor speed signal”). Alternatively or in addition, at least one sensor 300 transmits a signal representative of a measured rotational speed of generator 132, a measured rotational speed of rotor shaft 134, a measured rotational speed of high speed shaft 138, and/or a measured rotational speed of any suitable component of wind turbine 100 and/or brake system 200. Moreover, a braking operation and/or any other force transmitted to drive train 156 may induce one or more vibrations and/or oscillations to one or more components of drive train 156. Such vibrations and/or oscillations may cause a variation in a rotational speed and/or an acceleration of one or more drive train components, such as within rotor 108, rotor shaft 134, high speed shaft 138, and/or any suitable component of drive train 156. When sensor 300 measures one or more operating conditions of wind turbine 100, the vibrations and/or oscillations may also be measured and incorporated within the sensor signal, such as the rotor speed signal.

In the exemplary embodiment, calculation module 302 processes and/or performs at least one operation on a signal received from sensor 300. In a specific embodiment, calculation module 302 differentiates (i.e., performs a derivative operation on) the rotor speed signal to calculate an acceleration of rotor 108. Calculation module 302 transmits a signal representative of the acceleration of rotor 108 (hereinafter referred to as a “rotor acceleration signal”) to a filter module 304. The rotor acceleration signal includes a plurality of signal components that have one or more oscillational characteristics, such as a frequency and/or an amplitude of one or more oscillations or vibrations. More specifically, the rotor acceleration signal includes a signal component representative of a drive train oscillation and may include a signal component representative of an acceleration due a braking operation (i.e., a deceleration caused by an operation of brake 202). Alternatively, calculation module 302 transmits any suitable signal to filter module 304 after processing and/or performing at least one operation on the signal.

Filter module 304 performs a filtering operation on the rotor acceleration signal and/or on any other suitable signal received. More specifically, in the exemplary embodiment, filter module 304 includes a band-pass filter that filters the rotor acceleration signal received. The band-pass frequency is substantially equal to a natural oscillational frequency, or Eigen frequency, of drive train 156. As used herein, the natural oscillational frequency of drive train 156 refers to an oscillational frequency of drive train 156 and/or a component of drive train 156 that is present within drive train 156 during an operation of wind turbine 100 when brake system 200 is not engaged. Alternatively, the band-pass frequency is substantially equal to a natural frequency of rotor 108, a natural frequency of rotor shaft 134, a natural frequency of high speed shaft 138, a natural frequency of generator 132, and/or a natural frequency of any suitable component of wind turbine 100 and/or brake system 200. In the exemplary embodiment, filter module 304 substantially filters the rotor acceleration signal with the Eigen frequency of the drive train to substantially remove a low frequency deceleration component of the rotor acceleration signal (e.g., a deceleration component induced by the main braking action of brake system 202 described above with reference to FIG. 3). As such, filter module 304 isolates and/or extracts a filtered acceleration signal that represents the drive train oscillation signal component and transmits the filtered acceleration signal to brake control module 306.

In the exemplary embodiment, brake control module 306 selectively controls an operation of brake 202 based on an oscillational characteristic of at least one component of wind turbine 100, such as based on the filtered acceleration signal. More specifically, brake control module 306 transmits a brake engagement signal to brake control system 204 to selectively engage and disengage brake 202 synchronously with respect to the filtered acceleration signal. In the exemplary embodiment, the filtered acceleration signal oscillates between a positive polarity and a negative polarity as a result of the drive train oscillations. A positive polarity of the filtered acceleration signal indicates that the wind turbine component is accelerating. Similarly, a negative polarity of the filtered acceleration signal indicates that the wind turbine component is decelerating. Accordingly, brake 202 is engaged when the filtered acceleration signal has a positive polarity, and brake 202 is disengaged when the filtered acceleration signal has a negative polarity. As the engagement of brake 202 induces a negative acceleration to high speed shaft 138, engaging brake 202 when the filtered acceleration signal has a positive polarity reduces or eliminates an amplitude of one or more drive train acceleration oscillations. Similarly, disengaging brake 202 when the filtered acceleration signal has a negative polarity also reduces or eliminates an amplitude of drive train acceleration oscillations.

Moreover, a delay may occur between a transmission of the brake engagement signal and an engagement and/or disengagement of brake 202 with drive train 156. In such a situation, brake control module 306 adjusts the operation of brake 204 to compensate for the delay. More specifically, brake control module 306 shifts or offsets the brake engagement signal by an amount substantially equal to an expected delay of the engagement of brake 202 such that brake 202 is engaged and/or disengaged when the polarity of the filtered acceleration signal is positive and/or is negative, respectively.

In the exemplary embodiment, calculation module 302, filter module 304, and/or brake control module 306 are at least partially implemented by turbine control system 150. Alternatively, calculation module 302, filter module 304, and/or brake control module 306 are implemented by any suitable system that enables brake control system 204 to operate as described herein.

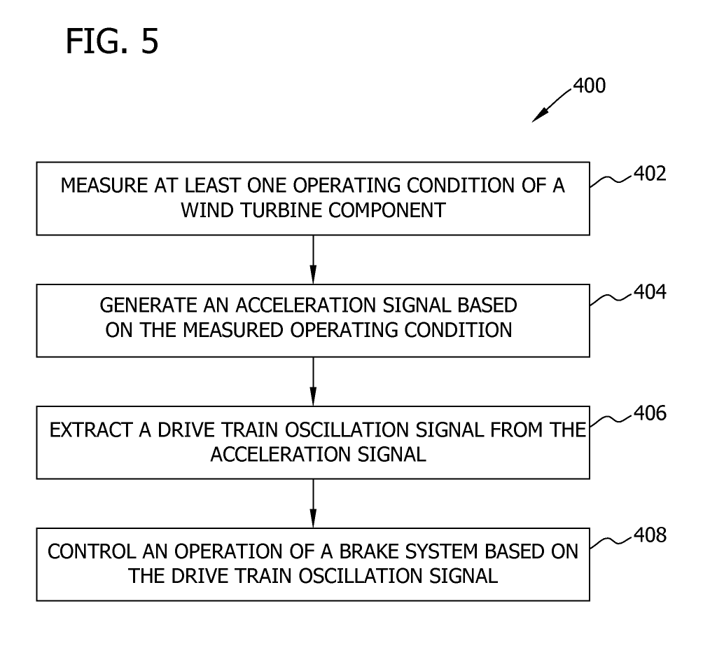

FIG. 5 is a flow diagram illustrating an exemplary method 400 for controlling a rotational speed of drive train 156 (shown in FIG. 2). In the exemplary embodiment, method 400 is at least partially implemented by a control system, such as turbine control system 150 (shown in FIG. 2). In the exemplary embodiment, method 400 includes measuring 402 at least one operating condition of a wind turbine component. For example, sensor 300 (shown in FIG. 4) measures 402 a rotational speed of rotor 108 (shown in FIG. 1) and generates a signal representative of the measured rotational speed. Alternatively, sensor 300 and/or any suitable device measures 402 any suitable operating condition and generates a representative signal.

An acceleration signal is generated 404 based on the measured operating condition, such as the measured rotational speed. For example, calculation module 302 (shown in FIG. 4) generates 404 an acceleration signal based on a measured rotational speed of rotor 108. Alternatively, calculation module 302 and/or any suitable device generates 404 an acceleration signal using any suitable measured operating condition.

A drive train oscillation signal is extracted 406 or isolated from the acceleration signal. More specifically, in the exemplary embodiment, filter module 304 (shown in FIG. 4) filters out at least one component of the acceleration signal to extract 406 the drive train oscillation signal (i.e., the filtered acceleration signal) from the acceleration signal. An operation of a brake system, such as brake control system 204 (shown in FIG. 3), is controlled 408 based on the drive train oscillation signal. For example, brake control module 306 (shown in FIG. 4) selectively engages and/or disengages brake 202 and/or brake caliper 208 to apply and/or release a braking force on brake disc 206 (all shown in FIG. 3). Moreover, in the exemplary embodiment, brake control module 306 engages brake 202 and/or brake caliper 208 when a polarity of the drive train oscillation signal is positive, and disengages brake 202 and/or brake caliper 208 when the polarity of the drive train oscillation signal is negative. As such, method 400 reduces and/or eliminates one or more oscillations and/or vibrations within drive train 156.

A technical effect of the system and method described herein includes at least one of: (a) extracting an oscillational characteristic of at least one component of a wind turbine from a first signal; and (b) selectively operating a brake based on an oscillational characteristic of at least one component of a wind turbine to reduce the oscillational characteristic, wherein the brake is configured to reduce a rotational speed of the drive train.

The above-described embodiments provide a brake system for reducing a rotational speed of a wind turbine and/or reducing or eliminating drive train oscillations within the wind turbine. The brake system induces an acceleration of a component of a drive shaft and a drive train oscillation signal is extracted. The brake system controls an activation and a deactivation of a brake based on the drive train oscillation signal. Accordingly, the brake system and the method described herein reduce and/or eliminate drive train oscillations within a wind turbine. As such, an operational life of one or more wind turbine components may be extended.

Exemplary embodiments of a wind turbine, a brake system, and a method for controlling a rotational speed of a wind turbine are described above in detail. The wind turbine, brake system, and method are not limited to the specific embodiments described herein, but rather, components of the wind turbine and/or brake system and/or steps of the method may be utilized independently and separately from other components and/or steps described herein. For example, the brake system may also be used in combination with other wind turbines and methods, and is not limited to practice with only the wind turbine and method as described herein. Rather, the exemplary embodiment can be implemented and utilized in connection with many other wind turbine applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wind turbine, comprising:
a drive train;
a brake configured to reduce a rotational speed of said drive train; and,
a brake control system operatively coupled to said brake, said brake control system configured to selectively operate said brake based on an oscillational characteristic of at least one component of said wind turbine.

2. A wind turbine in accordance with claim 1, wherein said brake control system further comprises a sensor in signal communication with said brake control system and configured to measure an operating condition of said wind turbine.

3. A wind turbine in accordance with claim 2, wherein said brake control system further comprises a calculation module configured to:
receive a signal representative of the operating condition of said wind turbine from said sensor; and,
calculate an acceleration of the component.

4. A wind turbine in accordance with claim 3, wherein said brake control system further comprises a filter module configured to:
receive a first signal representative of the calculated acceleration of the component from said calculation module; and,
extract a second signal representative of an oscillation of said drive train from the first signal.

5. A wind turbine in accordance with claim 4, wherein said filter module comprises a band-pass filter that is tuned to a natural oscillational frequency of said drive train.

6. A wind turbine in accordance with claim 1, wherein said brake control system is configured to generate a signal representative of an oscillation of said drive train.

7. A wind turbine in accordance with claim 6, wherein said brake control system is configured to:
engage said brake when a polarity of the signal is positive; and,
disengage said brake when the polarity of the signal is negative.

8. A brake system for a wind turbine including a drive train, said brake system comprising:
a brake configured to reduce a rotational speed of the drive train; and,
a brake control system operatively coupled to said brake, said brake control system configured to selectively operate said brake based on an oscillational characteristic of at least one component of the wind turbine.

9. A brake system in accordance with claim 8, wherein said brake control system further comprises a sensor in signal communication with said brake control system and configured to measure an operating condition of the wind turbine.

10. A brake system in accordance with claim 9, wherein said brake control system further comprises a calculation module configured to:
receive a first signal representative of the operating condition of the wind turbine from said sensor; and,
calculate an acceleration of the component.

11. A brake system in accordance with claim 10, wherein said brake control system further comprises a filter module configured to:
receive a second signal representative of the calculated acceleration of the component from said calculation module; and,
extract a third signal representative of an oscillation of the drive train from the second signal.

12. A brake system in accordance with claim 11, wherein said filter module comprises a band-pass filter that is tuned to a natural oscillational frequency of the drive train.

13. A brake system in accordance with claim 8, wherein said brake control system is configured to generate a signal representative of an oscillation of the drive train.

14. A brake system in accordance with claim 13, wherein said brake control system is configured to:
engage said brake when a polarity of the signal is positive; and,
disengage said brake when the polarity of the signal is negative.

15. A method for controlling a rotational speed of a wind turbine that includes a drive train and a brake coupled to the drive train, said method comprising:
extracting an oscillational characteristic of at least one component of the wind turbine from a first signal; and,
selectively operating the brake based on the oscillational characteristic to reduce the oscillational characteristic, the brake configured to reduce a rotational speed of the drive train.

16. A method in accordance with claim 15, further comprising measuring an operating condition of the wind turbine.

17. A method in accordance with claim 16, further comprising generating a second signal representative of an acceleration of the component based on the measured operating condition.

18. A method in accordance with claim 17, wherein the calculated acceleration of the component includes an acceleration component of the brake and an oscillational frequency of the drive train, said extracting an oscillational characteristic of at least one component of the wind turbine from a first signal further comprising extracting a third signal representative of an oscillation of the drive train from the second signal.

19. A method in accordance with claim 15, wherein the first signal is representative of an oscillation of the drive train, said method further comprising engaging the brake when a polarity of the first signal is positive.

20. A method in accordance with claim 19, further comprising disengaging the brake when a polarity of the first signal is negative.
